(19) United States
(12) Patent Application Publication
(10) Pub. No.: US 2012/0213880 A1
(43) Pub. Date: Aug. 23, 2012

(54) MOLD FOR FORMING SKIN-INTEGRATED FOAM ARTICLE

(75) Inventors: Tomoki NII, Kasugai-shi (JP); Masami NAKANE, Toyota-shi (JP)

(73) Assignee: TOYOTA BOSHOKU KABUSHIKI KAISHA, Aichi-ken (JP)

(21) Appl. No.: 13/401,261

(22) Filed: Feb. 21, 2012

(30) Foreign Application Priority Data
Feb. 23, 2011 (JP) 2011-036715

(51) Int. Cl. B29C 44/58

(52) U.S. Cl. 425/4 R

(57) ABSTRACT

A mold for forming a skin-integrated foam article, by setting a planar skin material in a cavity, and foam-molding a foam body in the cavity, so that the foam body adheres integrally to the skin material, is disclosed. The mold has a core mold that is pressed against a surface of a part of the skin material set in the cavity when the core mold is placed in a closed position, and forms a hollow portion that is open to the surface of the part of the skin material, in the foam body. The core mold has a protrusion formed on a pressing face thereof which is pressed against the surface of the part of the skin material, and the protrusion is pressed against the surface of the part of the skin material.

### INCORPORATION BY REFERENCE

The disclosure of Japanese Patent Application No. 2011-036715 filed on Feb. 23, 2011 including the specification, drawings and abstract is incorporated herein by reference in its entirety.

### BACKGROUND OF THE INVENTION

1. Field of the Invention

The invention relates to a mold for forming a skin-integrated foam article. More specifically, the invention is concerned with a mold for forming a skin-integrated foam article, by setting a planar skin material in a cavity of the mold, and foam-molding a foam body in the cavity, so that the foam body adheres integrally to the skin material.

2. Description of Related Art

In a known vehicle seat, a pad that serves as a cushion of the seat is formed by foam molding, such that the pad adheres integrally to a skin material. Japanese Patent Application Publication No. 2008-142244 (JP-A-2008-142244) discloses a method of foam-molding the pad so that the pad adheres integrally to the skin material. In the method as disclosed in this publication, when the pad is formed by foaming a urethane material, the urethane material is foamed or expanded in a condition in which the skin material is set in a mold in advance, so that the thus formed pad adheres integrally to the skin material.

In the case where the pad as disclosed in JP-A-2008-142244 is formed with an air channel for guiding air fed from a ventilator provided in the seat, to a back surface of the skin material, so that the air passes through the skin material and reaches a seat surface, an upper mold to be placed in a closed position is provided with a core mold for forming the air channel, and the pad is molded by foaming while the upper mold is placed in the closed position such that a distal end face of the core mold is pressed against the skin material. In this manner, the air channel that communicates with the back surface of the skin material can be formed in the pad. In this arrangement, however, if the core mold is pressed too strongly, against the skin material, uplift or elevation may appear in a portion of the skin material around the core mold, which may result in poor appearance after molding of the pad that adheres integrally to the skin material. If, on the other hand, the force with which the core mold is pressed against the skin material is small, the urethane material may enter or intrude into between the core mold and the skin material, due to the foaming pressure, and the opening of the air channel may be blocked or closed. The present invention has been developed in order to solve the above problem. It is therefore an object of the invention to form a hollow portion that provides an air channel in the foam body, with good appearance, in the molding of the skin-integrated foam article.

### SUMMARY OF THE INVENTION

A first aspect of the invention is concerned with a mold for forming a skin-integrated foam article, by setting a planar skin material in a cavity of the mold, and foam-molding a foam body in the cavity, so that the foam body adheres integrally to the skin material. The mold has a core mold that is pressed against a surface of a part of the skin material set in the cavity when the core mold is placed in a closed position, and forms a hollow portion that is open to the surface of the part of the skin material, in the foam body. The core mold has a protrusion formed on a pressing face thereof which is pressed against the surface of the part of the skin material, and the protrusion is pressed against the surface of the part of the skin material. The protrusion may be pressed against the surface of the part of the skin material before the pressing face reaches the surface of the part of the skin material, so as to inhibit entry of a foam material during foam molding of the foam body.

According to the first aspect of the invention, a portion of the core mold, or the protrusion, is pressed against the skin material, before the remaining portion of the core mold reaches the skin material; therefore, the amount or depth by which the core mold is pressed into the skin material can be easily controlled so that the entire area of the pressing face is prevented from being too strongly pressed into the skin material. More specifically, since the protrusion is pressed into the skin material by a sufficiently large amount or depth even if the amount of pressing of the pressing face into the skin material is small, the amount or depth by which the core mold is pressed into the skin material can be easily controlled so that the entire area of the pressing face will not too strongly pressed into the skin material. Accordingly, uplift or elevation of the skin material is less likely to appear around its portion pressed by the core mold, and the hollow portion can be favorably formed in the foam body, without deteriorating the appearance after molding.

In the first, aspect of the invention, the skin material may consist of an outer skin material, and a wadding material integrally laminated on an inner surface of the outer skin material, and the protrusion formed on the pressing face of the core mold may be pressed against and dug into the wadding material when the core mold is placed in the closed position.

With the above arrangement, the protrusion of the core mold is pressed against and dug into the wadding material of the skin material, so that foam molding of the foam body can be done with an improved appearance, without damaging the outer skin material. Also, with the wadding material laminated on the inner surface of the outer skin material, the touch and appearance of the skin material from the outside is favorably prevented, owing to the elasticity of the wadding material, from deteriorating due to formation of the hollow portion in the foam body.

Furthermore, the wadding material may have a two-layer structure consisting of a first layer and a second layer which are integrally laminated on each other, such that the first layer faces the cavity in which the foam body is molded by foaming, and the second layer faces an inner surface of the outer skin material. The first layer may have a lower air permeability than the second layer.

With the above arrangement, the first layer having the lower air permeability is disposed so as to face the cavity in which the foam body is molded by foaming, so that the foam material is prevented from entering, namely, permeating into the wadding material and curing, during foam molding of the foam body. Also, the second layer having the higher air permeability is disposed so as to face the inner surface of the outer skin material, thus assuring high air permeability or breathability at around the outer skin material.

In the mold as described above, the protrusion formed on the core mold may be formed in a double annular (or cylindrical shape) on the pressing face of the core mold. With this arrangement, the protrusion formed on the core mold is formed in a multiple annular shape, in the form of two or more rings arranged in radial directions on the pressing face of the core mold; therefore, even if there are variations in the amount of interference (the amount of pressing) by which each ring-like protrusion is pressed into the skin material, the entry of the foam material can be more favorably inhibited by any of the protrusions.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an external plan view of a seat cushion as an example of skin-integrated foam article according to a first embodiment of the invention;

FIG. 2 is a cross-sectional view taken along line II-II in FIG. 1;

FIG. 3A is a cross-sectional view showing a condition in which a skin material is set in a mold;

FIG. 3B is, an enlarged view of a portion denoted by IIIB in FIG. 3A;

FIG. 4A is a cross-sectional view showing a condition in which the mold is placed in a closed position;

FIG. 4B is an enlarged view of a portion denoted by IVB in FIG. 4A;

FIG. 5A is a cross-sectional view showing a condition in which a pad is molded by foaming;

FIG. 5B is an enlarged view of a portion denoted by VB in FIG. 5A;

FIG. 6 is a cross-sectional view showing a condition in which an upper mold is removed after molding;

FIG. 7 is a cross-sectional view of a principal part of the mold, showing a condition where the core mold is pressed into the skin material by a small amount or depth;

FIG. 8 is a cross-sectional view of a principal part of a comparative example in which no protrusion is formed on the core mold, showing a condition in which the amount of pressing of the core mold is too large; and

FIG. 9 is a cross-sectional view of the principal part of the comparative example, showing a condition in which the amount of pressing of the core mold is too small.

### DETAILED DESCRIPTION OF EMBODIMENTS

One embodiment of the invention will be described with reference to the drawings.

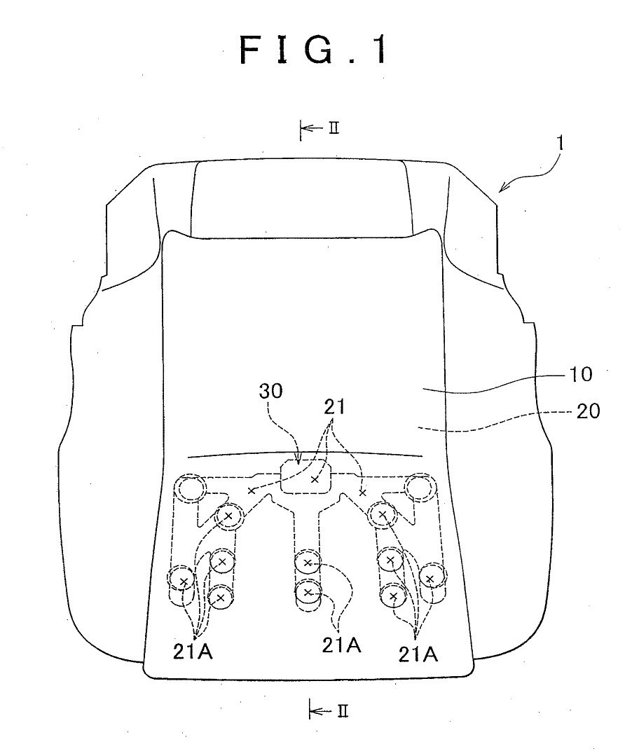

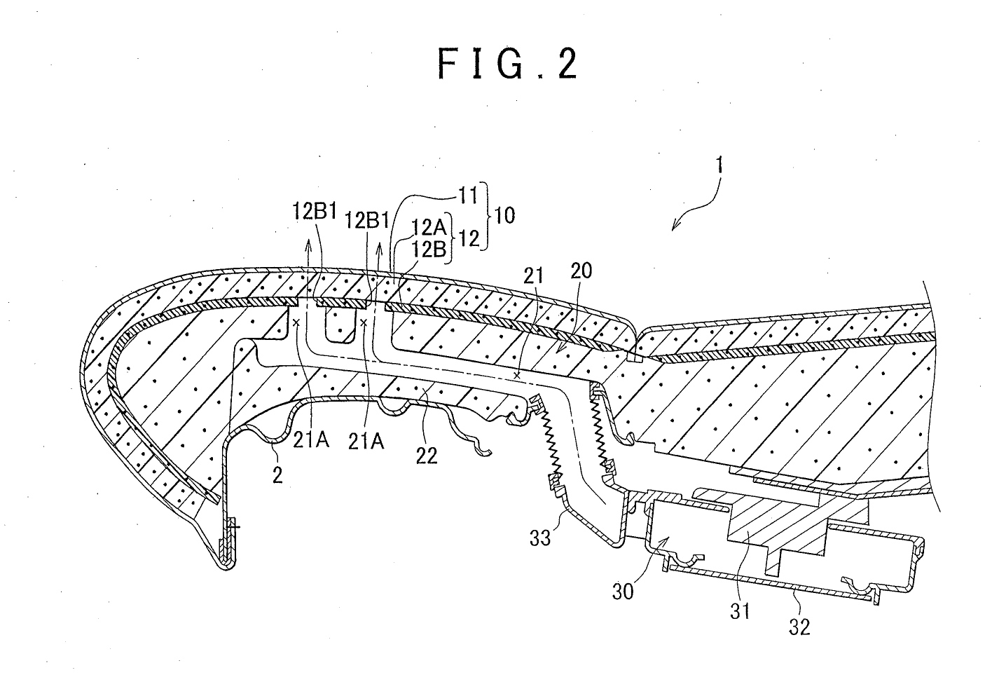

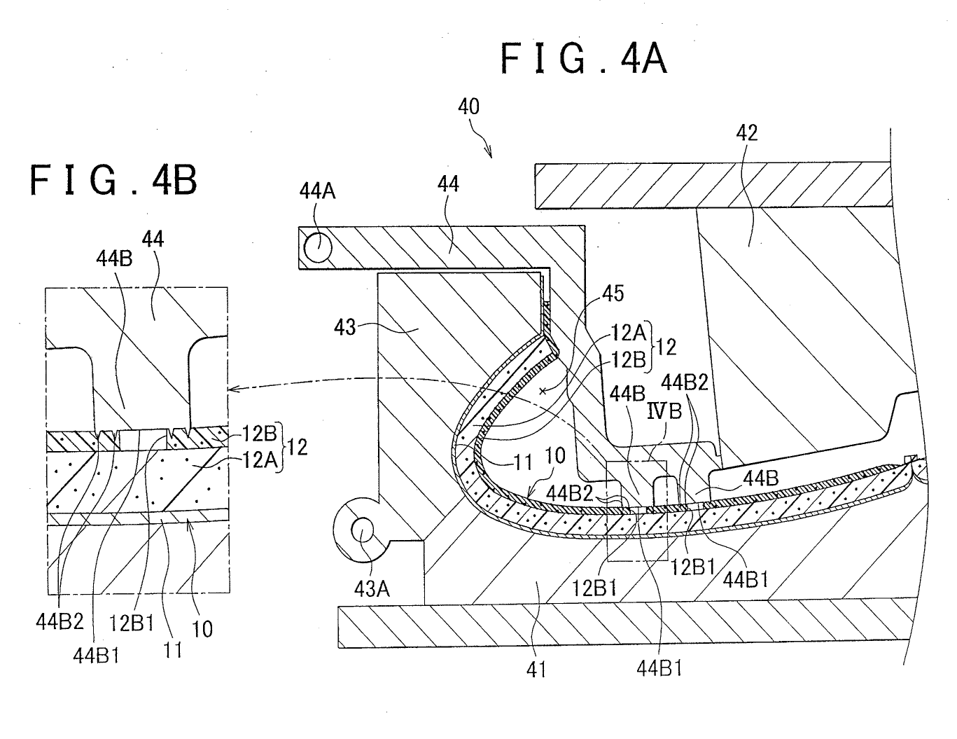

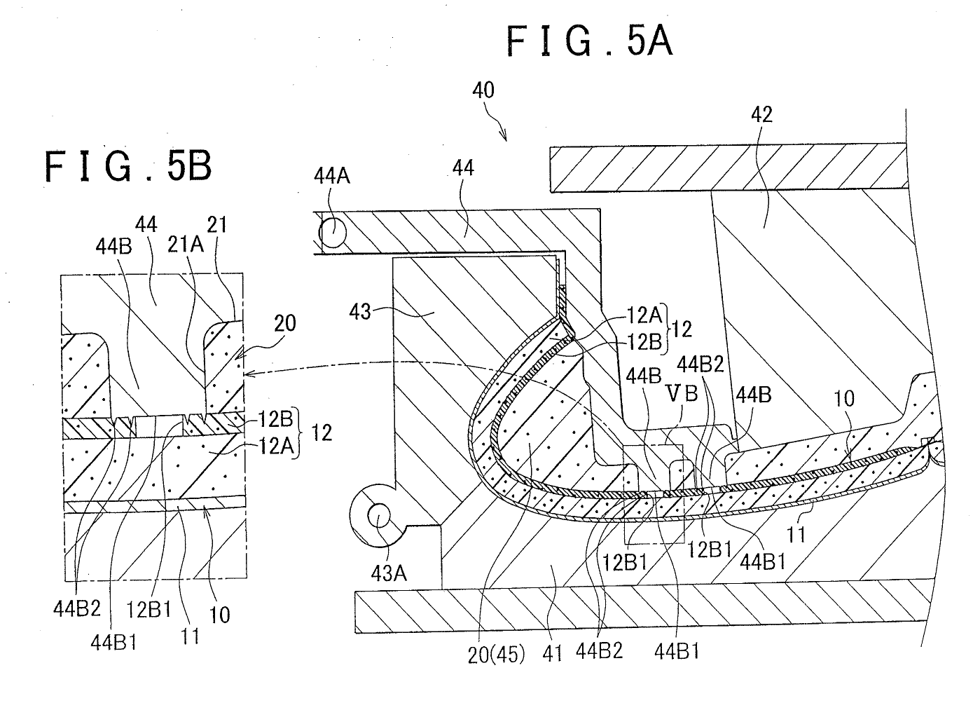

Initially, the construction of a mold for forming a skin-integrated foam article according to a first embodiment of the invention will be described with reference to FIG. 1 through FIG. 9. As shown in FIG. 1 and FIG. 2, the mold for forming the skin-integrated foam article of this embodiment is constructed as a mold 40 (see FIG. 5A) for foam-molding a pad 20 that provides a cushion body of a seat cushion 1 of a vehicle seat. In this embodiment, the pad 20 functions as “foam body” of the invention. More specifically, a skin material 10 is laid or placed over the interior surface of the mold 40 prior to foam molding of the pad 20 in the mold 40, as shown in FIG. 4A and FIG. 5A, so that the pad 20 can be molded into a condition in which the pad 20 adheres integrally to the skin material 10. During foam molding of the pad 20, air channels 21 (which function as “hollow portions” of the invention) are formed in the molded pad 20a, by means of a core mold 44 (which will be described later) as a part of the mold 40. In operation, air delivered from a ventilator 30 (see FIG. 2) installed in the seat cushion 1 as will be described later is allowed to pass through the air channels 21. In the following, the basic construction of the seat cushion 1, and the specific construction of the mold 40 will be described.

As shown in FIG. 2, the seat cushion 1 consists principally of a cushion frame 2, pad 20, and the skin material 10 that covers the entire surface of the pad 20. The cushion frame 2 is constructed such that a support structure (such as S springs or a plate-like panel) that supports the pad 20 at the bottom thereof spans or extends over a frame (not shown) that forms the framework of a peripheral portion of the seat cushion 1. To form the pad 20, urethane resin as a foam material is injected into a cavity 45 (see FIG. 4A) of the mold 40, to be expanded and molded, so that the pad 20 is formed into the shape of the cavity 45, to thus provide the appearance configuration of the seat cushion 1. As shown in FIG. 2, the skin material 10 has a laminated structure in which a fabric cover 11 (in the form of a sheet) and a thin-plate-like wadding material 12 located on a back surface (inner surface) of the fabric cover 11 and formed from a foam of urethane resin are integrally laminated on each other. In this embodiment, the fabric cover 11 functions as “outer skin material” of the invention.

The wadding material 12 has a two-layer structure comprised of a low-permeability layer 12B formed from a foam of urethane resin having a lower air permeability than the pad 20, and a high-permeability layer 12A formed from a foam of urethane resin having a higher air permeability than the low-permeability layer 12B. The low-permeability layer 12B and high-permeability layer 12A are integrally laminated on each other, such that the low-permeability layer 12B faces the pad 20, and the high-permeability layer 12A faces the back surface of the fabric cover 11. As shown in FIG. 4A and FIG. 5A, when the skin material 10 is set in the mold 40, and the pad 20 is molded by foaming, the low-permeability layer 12B faces the interior of the cavity 45. In this condition, the pad 20 is molded by foaming on the back surface (the upper surface in FIG. 5A) of the low-permeability layer 12B, as shown in FIG. 5A, so that the low-permeability layer 12B can prevent the foam material from permeating into the wadding material 12 and curing. Accordingly, the pad 20 can be favorably molded by foaming. Also, since the high-permeability layer 12A of the wadding material 12 faces the fabric cover 11, namely, the high-permeability layer 12A is located on the back surface of the fabric cover 11, as shown in FIG. 2, a surface portion of the skin material 10 exhibits high air permeability or breathability.

As shown in FIG. 1 and FIG. 2, the air channels 21 formed in the pad 20 serve to widely spread or distribute air fed from the ventilator 30 installed below the seat cushion 1, in the seat width direction (the lateral direction on the paper of FIG. 1) within the pad 20, and guide the distributed air streams to the back surface of the skin material 10 so that the air passes through the skin material 10 and reaches the seat surface. The air channels 21 include a cavity formed in a middle portion of the bottom of the pad 20, and a plurality of branches that are arranged in the seat width direction and extend in the pad 20 from the cavity toward the front of the seat. As shown in FIG. 1, two or more apertures 21A shaped like circular tubes and connected to each of the air channels 21 are formed in the pad 20 such that the apertures 21 communicate the air channel 21 with the back surface of the skin material 10. As shown in FIG. 2, a duct 33 connected to an air outlet of the ventilator 30 is connected to the cavity formed in the middle portion of the bottom of the pad 20 to provide an upstream air inlet of each of the air channels 21.

The ventilator 30 is fixed to a bottom portion of the cushion frame 2, and an air inlet 32 that is open downwardly of the seat is formed in a disc-shaped bottom of a container (main body) of the ventilator 30. In operation, air introduced via the air inlet 32 is delivered out of the ventilator 30 through the duct 33, through rotation of a fan 31 provided in the container. The air fed from the duct 33 passes through the air channels 21, to be distributed in the seat width direction, and passes through the apertures 21A formed in the pad 20 and the skin material 10, toward the surface of the seat cushion 2. Each of the air channels 21 and the apertures 21A are formed as hollow portions in the pad 20, by foam-molding the pad 20 using the mold 40 (which will be described below) while forming a groove for each of the air channels 21 and the apertures 21A, as shown in FIG. 5A, and then mounting a bottom pad 22 serving as a lid, on the bottom of the pad 20 from the downside as viewed in FIG. 2. In the following, a method of foam-molding the pad 20 integrally with the skin material 10, and forming the air channels 21 and the apertures 21A in the pad 20 will be described.

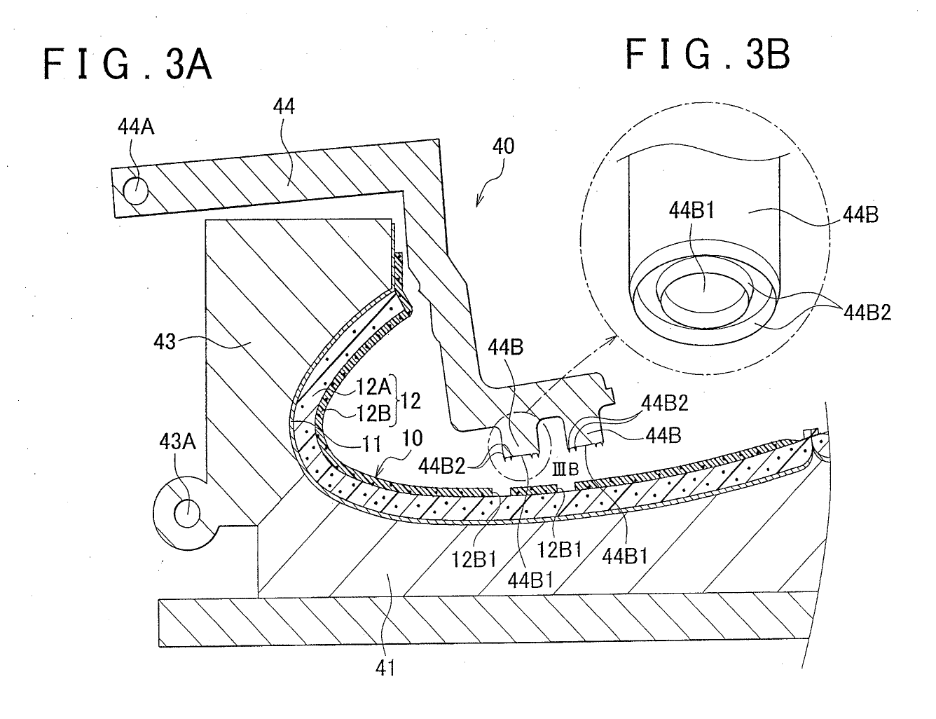

Referring to FIG. 3A through FIG. 5B, the basic construction of the mold 40 will be initially described. As shown in FIG. 3A, the mold 40 has a lower mold 41 and a front flap mold 43 which constitute a lower mold assembly having a mold surface on which the skin material 10 is laid, and a core mold 44 and an upper mold 42 which constitute an upper mold assembly that is placed in a closed position relative to the lower mold assembly. The lower mold 41 has a mold surface on which the skin material 10 is set, and is configured to form a surface of the most part of the seat cushion 1 through foam molding of the pad 20, as shown in FIG. 5A. The front flap mold 43 is arranged to rotate about a hinge 43A, to be placed in a closed position and an open position, and cooperates with the lower mold 41 to form a continuous mold surface when it is placed in the closed position. The front flap mold 43 is configured to form a front portion of the seat cushion 1. The core mold 44 is arranged to rotate about a hinge 44A, to be placed in a closed position and an open position, and includes two or more columnar pressing portions 44B that press corresponding portions on the surface of the skin material 10 set on the lower mold 41 when the core mold 44 is placed in the closed position, as shown in FIG. 4A. The core mold 44 and the pressing portions 44B form the above-mentioned air channels 21 and the apertures 21A in the pad 20, when the pad 20 is molded by foaming after the core mold 44 is placed in the closed position, as shown in FIG. 5A.

As shown in FIGS. 4A and 4B, through-holes 12B1 each having a circular cross-section that is smaller in size than a cross-section of each pressing portion 44B are formed in portions of the lower-permeability layer 12B of the wadding material 12 of the skin material 10 against which the respective pressing portions 44B of the core mold 44 are pressed. As shown in FIGS. 3A and 3B, each of the pressing portions 44B of the core mold 44 is formed with double annular protrusions 44B2 that protrude from a flat pressing face 44B1 of the bottom of the pressing portion 44B. The protrusions 44B2 are formed in cylindrical shape with a diameter larger than the diameter of each of the through-holes 12B1 formed in the low-permeability layer 12B. When the core mold 44 is placed in the closed position, as shown in FIG. 4A, the protrusions 44B2 of each pressing portion 44B are pressed and dug into the surface of the low-permeability layer 12B at positions surrounding the outer periphery of the corresponding through-hole 12B1. More specifically, one of the double protrusions 44B2 is formed on an outer peripheral portion of the disc-like pressing face 44B1 of each pressing portion 44B, and the other protrusion 44B2 is formed at a position radially inwardly of the outer peripheral portion, such that the two protrusions 44B2 are radially spaced apart from each other by a given distance. Each of the protrusions 44 is tapered toward its distal end, and has a triangular shape in cross section as shown in FIG. 4B. With each protrusion 44B thus formed in tapering cross-sectional shape, only local portions of the low-permeability layer 12B are likely to be pressed and dented, and a wide area or areas of the low-permeability layer 12B will not be pressed and dented.

With the core mold 44 thus constructed such that the protrusions 44B2 are formed on each of the pressing portions 44B, when the core mold 44 is placed in the closed position, the protrusions 44B2 are pressed against the surface of the low-permeability layer 12B, before the pressing faces 44B1 (disc-shaped bottoms) of the pressing portions 44B are pressed against the surface of the low-permeability layer 12B. Accordingly, when the pressing faces 44B1 reach the surface of the low-permeability layer 12B and are pressed against the surface, the protrusions 44B2 are already deeply engaged in the low-permeability layer 12B; therefore, sufficient pressing force can be applied from the protrusions 44B2 to the low-permeability layer 12B even if the pressing faces 44B1 are not deeply pressed into the low-permeability layer 12B.

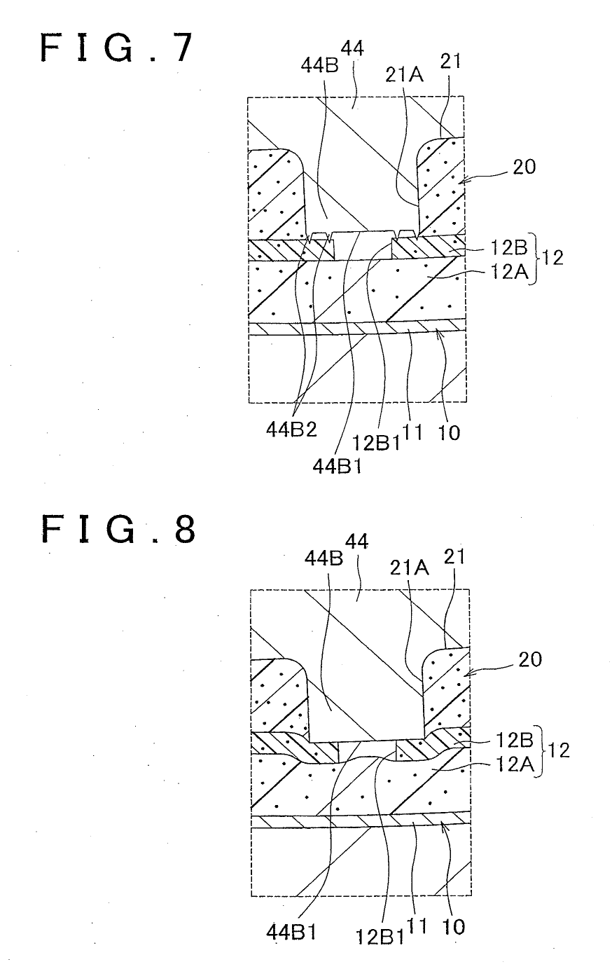

Thus, even if each pressing face 44B1 of each pressing portion 44B is not pressed down until it abuts on the low-permeability layer 12B when the core mold 44 is placed in the closed position, as shown in FIG. 7, the protrusions 44B2 exert certain pressing force that inhibits the foam material from entering each through-hole 12B1 of the low-permeability layer 12B during foam molding of the pad 20, on the surface of the low-permeability layer 12B. More specifically, with the double projections 44B2 thus provided at two different radii on each pressing portion 44B, even when the foam material pass under the radially outer protrusion 44B2 and enters the inside thereof while pressing down the low-permeability layer 12B under the foaming pressure, the foam material is prevented from entering further into the through-hole 12B1 due to the presence of the other, radially inner protrusion 44B2.

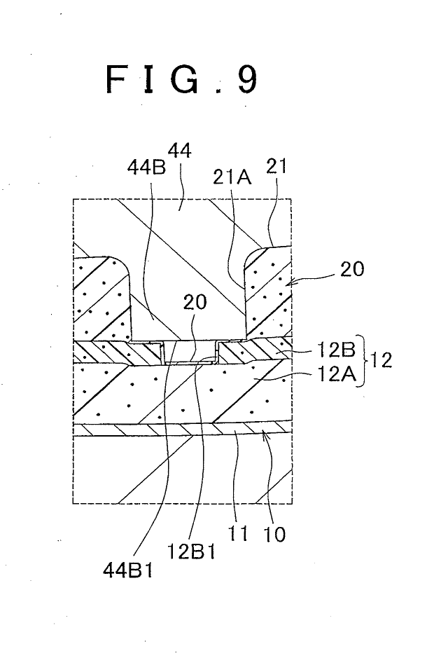

Thus, the provision of the protrusions 44B2 on each pressing portion 44B enables the pressing portion 44B to exert sufficiently large pressing force on the low-permeability layer 12B even if the pressing portion 44B is not pressed down so deeply. In the case of a comparative example as shown in FIG. 8, in which the above-described protrusions 44B2 are not provided on each pressing portion 44B of the core mold 44, the pressing face 44B1 of each pressing portion 44B is pressed deeply into the low-permeability layer 12B so that sufficiently large pressing force is applied to the low-permeability layer 12B. As a result, uplift (or elevation) occurs at portions of the skin material 10 in the vicinity of the through-holes 12B1 (in the vicinity of the pressing portions 44B). In this embodiment, on the other hand, when the seat cushion is removed from the mold after molding, the surface of the skin material 10 is prevented from being deformed into convex shape, which would occur if the uplift of the back surface of the skin material 10 affects the surface thereof due to the elasticity of the skin material 10. Also, in the case of a comparative example as shown in FIG. 9, in which the amount (or depth) by which each pressing face 44B1 of the core mold 44 is pressed into the low-permeability layer 12B is smaller than that of the example of FIG. 8, the force with which each pressing portion 44B presses the low-permeability layer 12B1 yields to the foaming pressure of the foam material, and the foam material intrudes into the corresponding through-hole 12B1 of the low-permeability layer 12B and blocks the through-hole 12B1. In this embodiment, on the other hand, the foam material that forms the pad 20 is prevented from intruding into and blocking the through-holes 12B1.

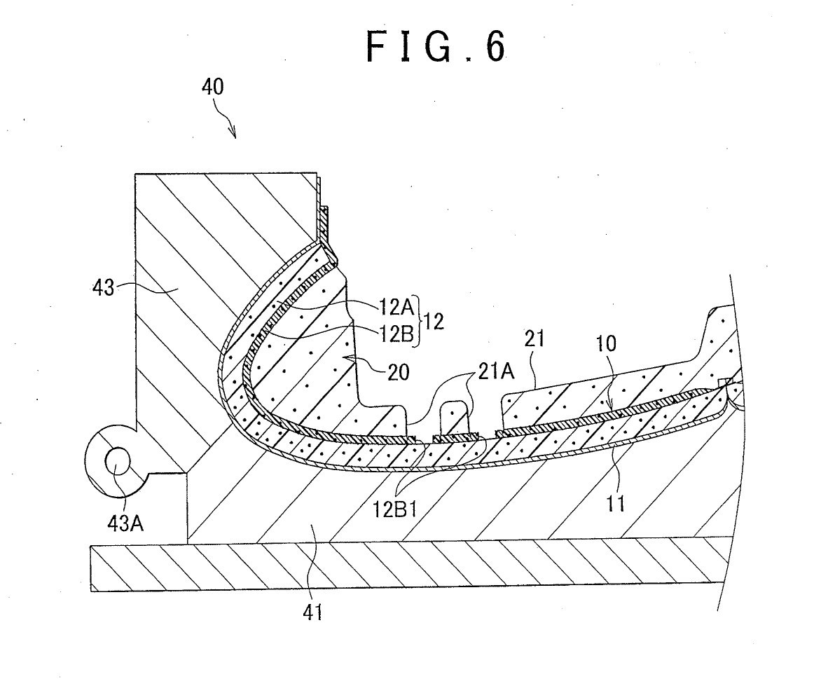

Next, a method of using the mold 40 according to this embodiment, namely, a method of foam-molding the pad 20 into a condition in which the pad 20 adheres integrally to the skin material 10, using the mold 40, will be described. Initially, after the front flap mold 43 is placed in the closed position, and cooperates with the lower mold 41 to form a continuous mold surface, as shown in FIG. 3A, the skin material 10 is laid down on the mold surface, and is attached firmly to the mold surface through vacuuming. Then, as shown in FIG. 4A, the core mold 44 is placed in the closed position, and each of the pressing portions 44B of the core mold 44 is pressed against the surface of the low-permeability layer 12B of the skin material 10. In this condition, the foam material is injected into the mold, and the upper mold 42 is placed in the closed position. Then, the foam material is foamed or expanded in the cavity 45 defined by the upper mold 42, the core mold 43 and the skin material 10. As a result, the cavity 45 is filled with the foam material thus foamed or expanded, as shown in FIG. 5A, and the pad 20 is formed such that the pad 20 adheres integrally to the skin material 10 due to chemical reaction during the foam molding. In this manner, the apertures 21A that communicate with the respective through-holes 12B1 of the low-permeability layer 12B of the skin material 10 and the air channels 21 are formed in the pad 20 thus molded, as shown in FIG. 6.

With the mold (mold 40) for forming the skin-integrated foam article thus constructed according to this embodiment, the protrusions 44B of the core mold 44 are pressed against the skin material 10 earlier than the remaining portions, which makes it easier to control the amount (or depth) by, which the core mold 44 is pressed into the skin material 10 so that the entire areas of the pressing faces 44B1 are not excessively strongly pressed into the skin material 10: More specifically, even if the amount or depth by which the pressing faces 44B1 of the core mold 44 are pressed into the skin material 10 is small, the protrusions 44B2 are pressed into the skin material 10 by a sufficient amount or depth prior to pressing of the pressing faces 44B1; therefore, the amount or depth of pressing can be easily controlled so that the entire areas of the pressing faces 44B1 are not too strongly pressed into the skin material 10. Accordingly, uplift or elevation is less likely or unlikely to appear around portions of the skin material 10 pressed by the core mold 44 (or within the through-holes 12B1), and the air channels 21 (hollow portions) can be favorably formed in the pad 20 (foam body) without deteriorating the appearance after the molding.

Also, the protrusions 44B2 of the core mold 44 are arranged to be pressed against and dug into the wadding material 12 of the skin material 10, so that the pad 20 having an improved appearance can be molded by foaming, without damaging the fabric cover 11 (outer skin material) that provides a skin (or outermost layer) of the skin material 10. Also, since the wadding material 12 is laminated on the back surface (inner surface) of the fabric cover 11, the touch and appearance of the skin material 10 from the outside can be favorably prevented from deteriorating due to formation of the air channels 21 in the pad 20, owing to the elasticity or resilience of the wadding material 12.

Also, a layer (low-permeability layer 12B) of the wadding material 12 having the lower permeability is disposed so as to face the cavity 45 in which the pad 20 is molded by foaming, so that the foam material can be prevented from entering the wadding material 12, namely, from permeating into the wadding material 12 and curing, during foam molding of the pad 20. Also, a layer (high-permeability layer 12A) of the wadding material 12 having the higher permeability is disposed so as to face the inner surface of the fabric cover 11, thereby to maintain high air permeability at around the fabric cover 11.

The protrusions 44B2 formed on the core mold 44 are formed in multiple annular shape, namely, the ring-shaped protrusions 44B2 protrude at two different radii on each pressing face 44B of the core mold 44; therefore, even if there are variations in the amount (or depth) by which each annular protrusion 44B2 is pressed into the skin material 10, the foam material can be more favorably inhibited from entering the through-hole 12B1, owing to the multiple structure of the protrusions 44B2.

While one embodiment of the invention has been described above, the invention may be embodied in various forms other than those of the illustrated embodiment. While the skin material 10 of the illustrated embodiment has the laminated structure in which the wadding material 12 is integrally laminated on the inner surface of the fabric cover 11 (that functions as “outer skin material” of the invention) that provides a skin (the outermost layer) of the skin material 10, the skin material may have a single-layer structure. The skin material 10 may be provided with through-holes. While the wadding material 12 of the illustrated embodiment has a two-layer structure consisting of the low-permeability layer 12B that faces the pad 20, and the high-permeability layer 12A that faces the fabric cover 11, the wadding material may also have a single-layer structure. When the wadding material has a single-layer structure consisting of a low-permeability layer into which the foam material is less likely or unlikely to permeate, air fed from the air channels (that function as “hollow portions” of the invention) may be less likely or unlikely to pass through the wadding material and reach the surface of the skin material. In this case, therefore, the wadding material may be provided, with through-holes that communicate with the air channels, like the arrangement in the illustrated embodiment. When the wadding material has a single-layer structure consisting of a high-permeability layer, the through-holes that communicate with the air channels as indicated in the illustrated embodiment are not necessarily required, but attention needs to be paid to the increased likelihood of permeation and curing of the foam material in the wadding material during foam molding of the pad. While the outer skin material that forms the skin (outermost layer) of the skin material may be formed of a highly permeable material, like the fabric cover 11 as indicated in the illustrated embodiment, the outer skin material may be formed of a low-permeable material such as genuine leather. In this case, some means for providing air permeability, such as a multiplicity of minute holes formed in the skin material, needs to be provided, so as to ensure air permeability of the skin material.

While the protrusions are formed on the core mold in multiple (double) annular shape (or cylindrical shape), in the form of inner and outer rings radially arranged on each pressing face of the core mold, in the illustrated embodiment, the protrusions may be formed in multiple annular shape having three or more rings. Also, the amount of protrusion may differ from one protrusion to another; for example, the amount of protrusion of the outermost annular protrusion may be set to the largest value. Also, the protrusions are not necessarily formed in cylindrical shape, but may protrude locally at required locations. When the protrusions are in the form of tubes, they may protrude in the form of tubes (e.g., square or rectangular tubes) other than cylinders.

What is claimed is:

1. A mold for forming a skin-integrated foam article, by setting a planar skin material in a cavity of the mold, and foam-molding a foam body in the cavity, so that the foam body adheres integrally to the skin material, comprising:
a core mold that is pressed against a surface of a part of the skin material set in the cavity when the core mold is placed in a closed position, and forms a hollow portion that is open to the surface of the part of the skin material, in the foam body,
wherein the core mold has a protrusion formed on a pressing face thereof which is pressed against the surface of the part of the skin material, and the protrusion is pressed against the surface of the part of the skin material.

2. The mold for forming a skin-integrated foam article according to claim 1, wherein:
the protrusion is pressed against the surface of the part of the skin material before the pressing face reaches the surface of the part of the skin material, so as to inhibit entry of a foam material during foam molding of the foam body.

3. The mold for forming a skin-integrated foam article according to claim 2, wherein:
the skin material comprises an outer skin material, and a wadding material integrally laminated on an inner surface of the outer skin material; and
the protrusion formed on the pressing face of the core mold is pressed against and dug into the wadding material when the core mold is placed in the closed position.

4. The mold for forming a skin-integrated foam article according to claim 3, wherein the wadding material has a two-layer structure comprising a first layer and a second layer which are integrally laminated on each other, such that the first layer faces the cavity in which the foam body is molded by foaming, and the second layer faces an inner surface of the outer skin material, the first layer having a lower air permeability than the second layer.

5. The mold for forming a skin-integrated foam article according to claim 4, wherein:
a through-hole is formed in a portion of the first layer of the wadding material against which the pressing face of the core mold is pressed; and
the protrusion formed on the pressing face is pressed against the wadding material at a position where the protrusion surrounds the through-hole, when the core mold is placed in the closed position.

6. The mold for forming a skin-integrated foam article according to claim 1, wherein:
a through-hole is formed in a portion of the skin material against which the pressing face of the core mold is pressed; and
the protrusion formed on the pressing face is pressed against the skin material at a position where the protrusion surrounds the through-hole, when the core mold is placed in the closed position.

7. The mold for forming a skin-integrated foam article according to claim 1, wherein the protrusion is formed in a cylindrical shape.

8. The mold for forming a skin-integrated foam article according to claim 7, wherein the protrusion is formed in an at least double cylindrical shape on the pressing face of the core mold.

9. The mold for forming a skin-integrated foam article according to claim 1, wherein the protrusion has a triangular shape in vertical cross section, and is tapered toward a distal end of the protrusion.
